(19) United States
(12) Patent Application Publication
(10) Pub. No.: US 2022/0395987 A1
(43) Pub. Date: Dec. 15, 2022

(54) VACUUM GRIPPING SYSTEM WITH EXTENDING GRIPPER ARM

(71) Applicant: Plus One Robotics, Inc., San Antonio, TX (US)

(72) Inventors: Paul Hvass, San Antonio, TX (US); Matt Churchill, Collinsville, CT (US)

(21) Appl. No.: 17/836,708

(22) Filed: Jun. 9, 2022

Related U.S. Application Data
(60) Provisional application No. 63/208,965, filed on Jun. 9, 2021.
(60) Provisional application No. 63/320,757, filed on Mar. 17, 2022.

(51) Int. Cl. B25J 15/06; B25J 15/00

(52) U.S. Cl. CPC B25J 15/0625; B25J 15/0052

(57) ABSTRACT

A vacuum gripping system for grabbing and releasing an object has a base frame for operably engaging a robotic arm. The base frame includes a pneumatic source connector. The system also includes an extendable member configured to extend and retract relative to the base frame. The extendable member has a distal end and a proximal end. The extendable member also has an extended position and a retracted position defining a range of motion therebetween. The system further includes a vacuum cup coupled to the distal end of the extendable member. Still further, the system includes a pneumatic pathway extending from the vacuum cup to the pneumatic source connector. The pneumatic pathway passes through the extendable member such that the vacuum cup remains in pneumatic communication with the pneumatic source connector throughout the range of motion of the extendable member.

### CROSS-REFERENCE TO RELATED APPLICATIONS

This application claims priority to U.S. Provisional Patent Application No. 63/208,965 filed on Jun. 9, 2021, entitled “VACUUM GRIPPING SYSTEM WITH EXTENDING GRIPPER ARM,” and to U.S. Provisional Patent Application No. 63/320,757 filed on Mar. 17, 2022 entitled “VACUUM GRIPPING SYSTEM WITH EXTENDING GRIPPER ARM,” the contents of both of which are hereby incorporated herein by reference.

### BACKGROUND

### Field of the Art

This invention relates to a pneumatic vacuum gripping system with an extending gripper arm for grabbing objects. More particularly, the pneumatic gripping system may be operably secured to a robotic system without interfering with the movement of the extending gripper arm to better engage, hold, sort and move objects.

### Discussion of the State of the Art

Robotic systems with vacuum gripping engaging structures for grabbing, holding, sorting and moving objects are known. For example, U.S. Pat. No. 6,015,174, the disclosure of which is hereby incorporated by reference, discloses a universal end effector system applied to a robot that positions pliable “bellows,” which are more commonly known as vacuum cups, that compress and seal against the surface of an object to be moved. The system applies a pneumatic vacuum pressure within the sealed area of the bellows secured to the end effector of the object, thereby allowing the robot to lift and move the object. The system includes a control system with sensors and the like that allows the vacuum to be engaged and released on demand, and/or based on predetermined sensed criteria, to allow objects gripped by the end effector to be grabbed, moved, and released by the robot as desired. Efforts to improve on this basic vacuum gripping system have included adding additional gripping technology to the working end of the gripper. For example, U.S. Pat. No. 7,963,578, the disclosure of which is hereby incorporated by reference, teaches using an electro-magnet into the gripper that works alone or in tandem with the pneumatic vacuum gripping system.

Currently available grippers, however, have some significant drawbacks that make the grippers less desirable and potentially unusable in certain scenarios. Generally, an array of suction cups is needed to pick objects of a variety of different masses, shapes, and sizes. However, in order to effectively pick various objects and create an effective seal between the suction cups and the object, it is desirable to apply an even amount of pressure across all of the suction cups. But it is often difficult to do so when the objects are malleable or compliant and/or have a significant amount of contour to them relative to the arrangement of the suction cups in an array. In these scenarios, currently available gripper systems will tend to fail because they are unable to apply even pressure across the suction cup array. As such, currently available gripper systems are unreliable especially when deployed in the situations described above (i.e. when picking highly contoured objects and/or compliant objects), especially in large scale, fast moving industrial systems.

Some have tried to overcome this limitation by applying excessive top-down force on the object via the gripper to compress the object (thereby somewhat straightening or smoothing some of the contoured surfaces) in an effort to form an effective seal between the objects and all of the suction cups within an array of suction cups. However, this approach introduces new limitations and/or problems. For example, an excessive amount of force may break or damage the object that the gripper is trying to pick. In other scenarios, the excessive pressure may break or damage the workcell or a conveyor belt that houses the object and/or may damage the robotic arm and/or the robotic end effector. For example, in some of these scenarios, the robot end effector effectively collides with the object, which causes an over amp in some of the motors, which may put the entire workcell down because the robot has effectively crashed.

This problem is exacerbated when the pick point selection system is not accurate. Certain pick point selection systems are not able to identify a pick location with sufficient accuracy. For example, an error of three inches along the vertical or gravitational axis of a pick point may cause the end effector to overshoot by, for example, compressing the object three inches in a first instance. Moreover, the excessive top-down force strategy may cause the object to compress an additional three inches for a total of six inches. This additional pressure may cause certain workcells and/or the robotic systems to break down as described above.

Others have tried to overcome these limitations by using a spring based pogo system. However, these spring-based pogo systems have hoses routed externally that enable negative pressure to be applied to the suction cups. These systems suffer from a variety of issues that may make them undesirable or unusable in certain circumstances. For example, the externally routed hoses snag on things, which adds to maintenance costs. Moreover, the externally routed hoses add stiffness to the entire structure, which make them difficult to use. In addition, these systems further exacerbate the problems discussed above by the physical limitations associated with currently available gripper systems. Currently available gripper systems, for example, provide vacuum pressure to the vacuum cups through external hoses extending from the base frame to the vacuum cups. The hoses are intended to be flexible so as not to interfere with the movement of the robot arm or a portion thereof. In practice, however, the hose material and thickness combined with the pressure built up within it, causes the hose to resist motion during use. This resistance may cause further inaccuracy and may compress packages more than desired especially if the excessive downward force strategy is applied.

### SUMMARY

The present invention overcomes these limitations by introducing elements in the robotic end effector that enable the robotic picking system to pick items within a compensation window. In other words, the elements of the robotic end effector that are disclosed herein enable the robotic end effector to pick items without applying significant additional pressure on an object, while at the same time improving the likelihood that even pressure is applied across all of the vacuum cups in an array when picking highly contoured objects and/or compliant objects.

More specifically, the present invention discloses a gripper device that is comprised of a spring compensator and a slip seal in the vacuum pathway that work with each other to enable the gripper device to pick a variety of objects—including highly contoured objects and/or compliant objects—without applying excessive pressure on the objects, while, at the same time, enabling even pressure across the vacuum cups in an array. In other words, the spring compensator and the slip seal in the vacuum pathway enable the gripper to have range of motion that accommodates two competing interests: flexing the vacuum cups enough to enable each vacuum cup to seal onto an object, while not deflecting too much (or having travel compensation) before the system crashes. The present invention facilitates additional deflection without interfering with the pneumatics of the system. The present invention provides mechanical compliance without restricting air flow.

Despite the benefits of the existing pneumatic vacuum gripping systems, there remains a need for a system that will effectively provide vacuum pressure from a base frame to the vacuum cups without compromising the deflection of an extendable arm extending therebetween. This present invention fulfills this and other needs as more fully explained in the specification and related figures.

In one disclosed embodiment, the vacuum gripping system for grabbing and releasing an object using a robotic arm has a base frame for operably engaging the robotic arm. The base frame includes a pneumatic source connector. The system also includes an extendable member configured to extend and retract relative to the base frame. The extendable member has a distal end and a proximal end. The extendable member also has an extended position and a retracted position defining a range of motion therebetween. The system further includes a vacuum cup coupled to the distal end of the extendable member. The vacuum cup is configured for operably engaging a surface of an object and forming a pneumatic seal on the surface. Still further, the system includes a pneumatic pathway extending from the vacuum cup to the pneumatic source connector. The pneumatic pathway passes through the extendable member such that the vacuum cup remains in pneumatic communication with the pneumatic source connector throughout the range of motion of the extendable member. Providing the pneumatic pathway inside the extendable member rather than having external vacuum supply lines has several advantages, as discussed in greater detail herein.

### BRIEF DESCRIPTION OF THE DRAWING FIGURES

The accompanying drawings, which are incorporated in and constitute a part of this specification, illustrate certain aspects of the instant invention and together with the description, serve to explain, without limitation, the principles of the invention. Like reference characters used therein indicate like parts throughout the several drawings.

FIG. 1 is a front, isometric view of a robotic system having a vacuum gripping system with an extendable gripper arm showing the gripper arm in a possible extended position in accordance with an embodiment of the invention.

FIG. 2 is a front, isometric view of the vacuum gripping system with an extendable gripper arm of FIG. 1 showing the gripper arm the extended position.

FIG. 3 is a front, isometric view of the vacuum gripping system with an extendable gripper arm of FIG. 1 showing the gripper arm in a possible retracted position.

FIG. 4 is a side plan view of the vacuum gripping system with an extendable gripper arm of FIG. 2 showing the gripper arm in the extended position.

FIG. 5 is a side plan view of the vacuum gripping system with an extendable gripper arm of FIG. 3 showing the gripper arm in the retracted position.

FIG. 6 is a cross-sectional view taken along line 6-6 of FIG. 2 showing the vacuum gripping system with an extendable gripper arm of FIG. 2 with the gripper arm in the extended position.

FIG. 7 is a cross-sectional view taken along line 7-7 of FIG. 3 showing the vacuum gripping system with an extendable gripper arm of FIG. 3 with the gripper arm in the retracted position.

FIG. 8 is a front, isometric view of a robotic system having a vacuum gripping system with an extendable gripper arm showing the gripper arm in a possible extended position in accordance with an alternative possible embodiment of the invention.

FIG. 9 is a front, isometric view of the vacuum gripping system with an extendable gripper arm of FIG. 8 showing the gripper arm the extended position.

FIG. 10 is a front, isometric view of the vacuum gripping system with an extendable gripper arm of FIG. 8 showing the gripper arm in a possible retracted position.

FIG. 11 is a side plan view of the vacuum gripping system with an extendable gripper arm of FIG. 9 showing the gripper arm in the extended position.

FIG. 12 is a side plan view of the vacuum gripping system with an extendable gripper arm of FIG. 10 showing the gripper arm in the retracted position.

FIG. 13 is a cross-sectional view taken along line 13-13 of FIG. 9 showing the vacuum gripping system with an extendable gripper arm of FIG. 9 with the gripper arm in the extended position.

FIG. 14 is a cross-sectional view taken along line 14-14 of FIG. 10 showing the vacuum gripping system with an extendable gripper arm of FIG. 10 with the gripper arm in the retracted position.

FIG. 15 is a perspective view of an extendable arm and compensator sleeve in accordance with one embodiment of the present invention.

FIG. 16 is a cross-sectional view of a vacuum gripping system with an extendable gripper arm in accordance with one embodiment of the present invention.

FIG. 17 is a perspective view of the extendable arm from FIG. 15.

FIG. 18 is a front plan view of the extendable arm depicted in FIG. 17.

FIG. 19 is a cross-sectional view taken along line B-B of FIG. 18 of the extendable arm.

FIG. 20 is a perspective view of the compensator sleeve from FIG. 15.

FIG. 21 is a front plan view of the compensator sleeve depicted in FIG. 20.

FIG. 22 is a cross-sectional view taken along line C-C of FIG. 21 of the compensator sleeve.

FIG. 23 is a front, isometric view of a robotic system having a vacuum gripping system with an extendable gripper arm showing the gripper arm in a possible extended position in accordance with one embodiment of the invention.

FIG. 24 is a front, isometric view of the vacuum gripping system with an extendable gripper arm of FIG. 23.

FIGS. 25 and 26 are cross-sectional views of the vacuum gripping system of FIG. 24.

FIG. 27 is a cross-sectional view of the distribution block of the vacuum gripping system of FIG. 24.

FIG. 28 is a front, isometric view of a robotic system having a vacuum gripping system with an extendable gripper arm showing the gripper arm in a possible extended position in accordance with one embodiment of the invention.

FIG. 29 is a front, isometric view of the vacuum gripping system with an extendable gripper arm of FIG. 28.

FIG. 30 is a cross-sectional view of the vacuum gripping system of FIG. 29.

FIG. 31 is a cross-sectional view of an upper distribution block of the vacuum gripping system of FIG. 29.

FIG. 32 is a cross-sectional view of a lower distribution block of the vacuum gripping system of FIG. 29.

FIG. 33 is a perspective view of a vacuum gripping system having a zone control mechanism, in accordance with one embodiment of the present invention.

FIG. 34 is a top planar view of a zone control switching block, in accordance with one embodiment of the present invention.

FIG. 35 is a top perspective view of the zone control switching block of FIG. 34.

FIG. 36 is a cross-sectional view of the zone control switching block of FIG. 34.

FIGS. 37 and 38 are top planar views of one of the switching plates of the zone control switching block in an “open” configuration and a “closed” configuration, respectively.

### DETAILED DESCRIPTION

The present invention is for a gripper device for parcel handling that is capable of handling a wide range of package types, including, but not limited to, shipping envelopes, flat envelopes, boxes, polybags, etc. More specifically, the gripper device of the present invention includes a spring compensator and a slip seal in the vacuum pathway that work with each other to enable the gripper device to pick a variety of objects—including objects that are malleable or may compress upon application of force—without introducing an excessive amount of stiffness to the overall gripper, which can (the force cause by stiffness) damage or otherwise break the cell that houses a bin/tote and/or the object.

By way of context, gripper devices like the ones of the present invention are typically tasked with picking objects based on computer generated pick points, which identify a grasping point for picking an object. However, with certain pick point generation systems, there can be some variance in how accurate the pick point is relative to an object in a tote or a bin of a pick cell. Moreover, there can be quite a bit of contour to the objects themselves because often, the objects can be fairly malleable or compliant.

The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

Generally, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

The present invention can be understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. Those skilled in the relevant art will recognize that many changes can be made to the aspects described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the terms “optional,” “optionally,” or “preferably” mean that the subsequently described event or circumstance may or may not occur, and that the description includes instances where said event or circumstance occurs and instances where it does not.

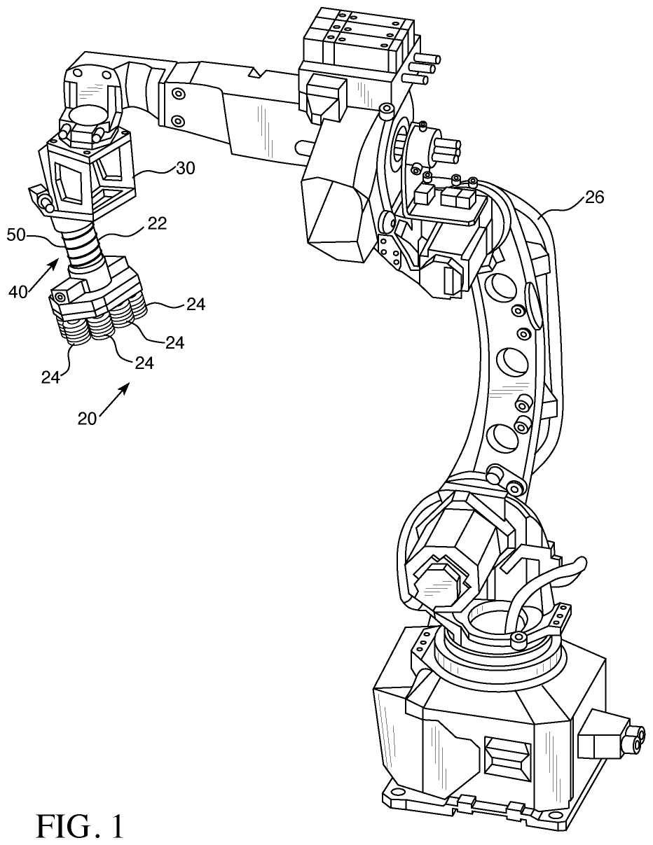

Referring now to the drawings, where like reference numbers correspond to like or similar components throughout the several figures, FIGS. 1-7 depict a pneumatic vacuum gripping system 20 with an extendable member 22 and multiple vacuum cups 24. As shown in FIG. 1, the pneumatic vacuum gripping system 20 may be operably connected to a conventional robotic arm 26 or the like. The robotic arm 26 may include servos, sensors, cameras, a pneumatic supply and related systems that allow it to locate and position one or more vacuum cups 24 of the pneumatic vacuum gripping system 20 to engage an object (not shown).

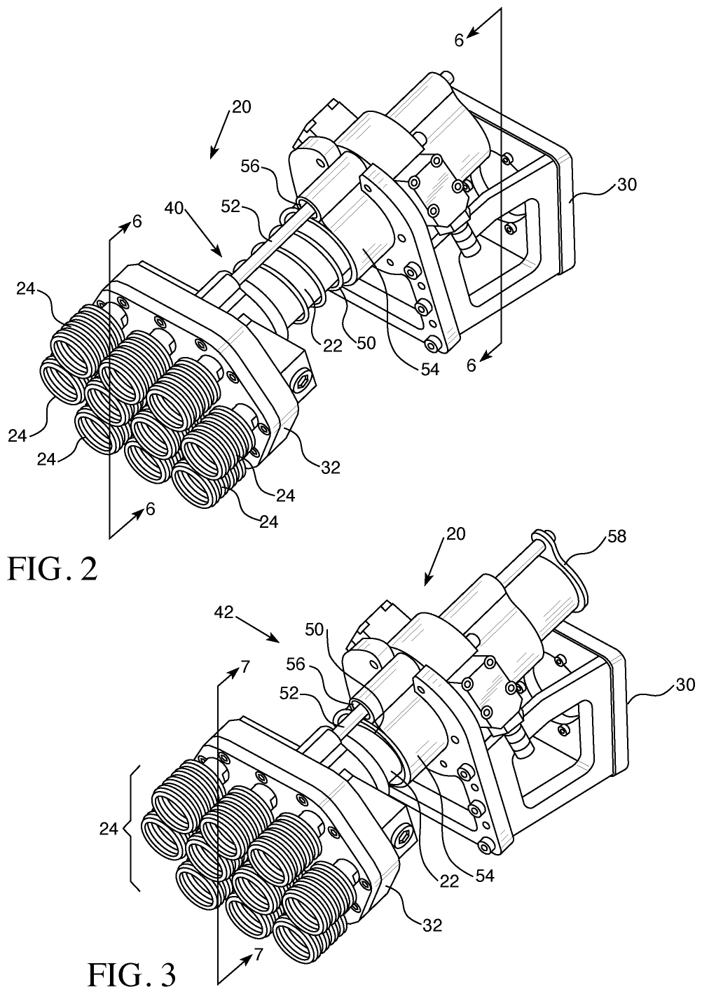

As best shown in FIGS. 2 and 3, the vacuum gripping system 20 has a base frame 30 for operably engaging the robotic arm 26, and a plurality of resilient vacuum cups 24 operably extending from a cup frame 32 at the distal end of the extendable member 22. The extendable member 22 is disposed between the base frame 30 and the cup frame 32. The extendable member 22 has a defined range of motion that includes an extended position 40 shown in FIGS. 1, 2, 4 and 6 and a retracted position 42 shown in FIGS. 3, 5 & 7. A biasing member 50, such as a coil spring or the like, is operably secured to the base frame 30 and the extendable member 22 to bias the extendable member 22 to its extended position 40 (FIG. 2). It can be appreciated that when the robotic arm 26 positions a vacuum cup 24 adjacent to an object to be grabbed, the extendable member 22 can retract as needed to account for positioning discrepancies and/or to limit the force asserted by the vacuum cup 24 on the object, thereby ensuring the vacuum cup 24 seals along the surface of the object to be grabbed. The biasing member 50 may be a compression spring that is biased to be in the extended position 40 and is configured to compress upon application of a small amount of force. As such, when an object is encountered, force exerted on the extendable member 22 by the object may cause the biasing member 50 to compress and the extendable member 22 to retract in order to compensate for any discrepancies in the pick point location of the object and avoid damage to the system. The load required to compress the biasing member 50 may be relatively small.

A compensation window is provided by the compression of the vacuum cup 24 and the extendable member 22. This compensation window compensates for any errors that may be present in the accuracy of the pick point location provided by the pick point selection system. The length of the compensation window is dependent upon the length of the biasing member 50. In one embodiment, spacers may be added to one or both ends of the biasing member 50 to shorten the compensation window without making any major modifications to the gripping system 20.

The vacuum gripping system 20 further includes a compensator sleeve 54 that surrounds the extendable member 22. The extendable member 22 translates linearly relative to the sleeve 54. The inner diameter of the compensator sleeve 54 is slightly larger than the outer diameter of the extendable member 22. In one example, the inner diameter of the compensator sleeve 54 may be no more than 0.1 mm larger than the outer diameter of the extendable member 22. In another example, the compensator sleeve 54 includes bushings on both ends to reduce the clearance between the compensator sleeve 54 and the extendable member 22. The tight clearance between the sleeve 54, or the sleeve bushings, and the extendable member 22 reduces air leakage in the vacuum pathway. The extendable member 22, compensator sleeve 54, and/or the bushings on both ends of the compensator sleeve 54 may be made from, or coated with, a low friction material.

If desired, a second retractable sliding alignment member 52 may be parallelly-aligned and positioned adjacent to the extendable member 22 to ensure smooth movement of the extendable member 22 along its defined range of motion and control the rotational orientation of the extendable member 22. The sliding alignment member 52 is disposed in an opening 56 in the compensator sleeve 54. A plate 58 (shown in FIGS. 3-7) attached to a proximal end of the extendable member 22 and the alignment member 52 acts as an end stop to prevent the extendable member 22 and the alignment member 52 from extending into the sleeve 54.

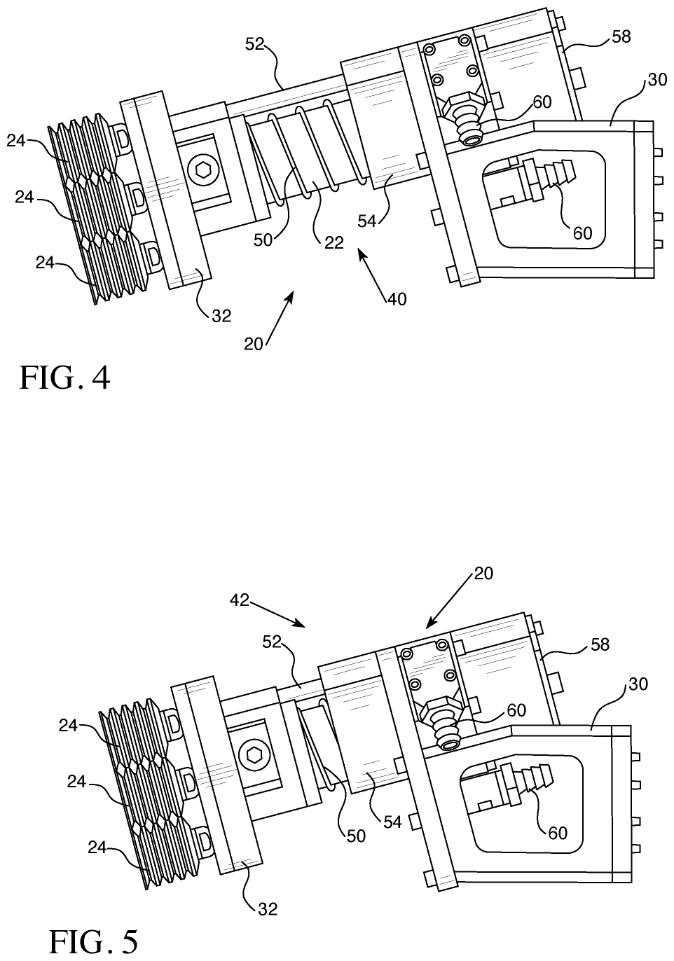

As best shown in FIGS. 4 and 5, the base frame 30 may include pneumatic connectors 60 for connecting a pneumatic supply line to the system 20. This pneumatic supply line delivers and removes vacuum pressure to the vacuum cups 24 via an internal pneumatic pathway (discussed in further detail below) based on predetermined criteria which may include information from pressure and other sensors and cameras operably secured to the robotic system, thereby allowing the vacuum cups 24 to operably grip and hold the object for movement by the robotic arm 26 and then release the object after it has been moved.

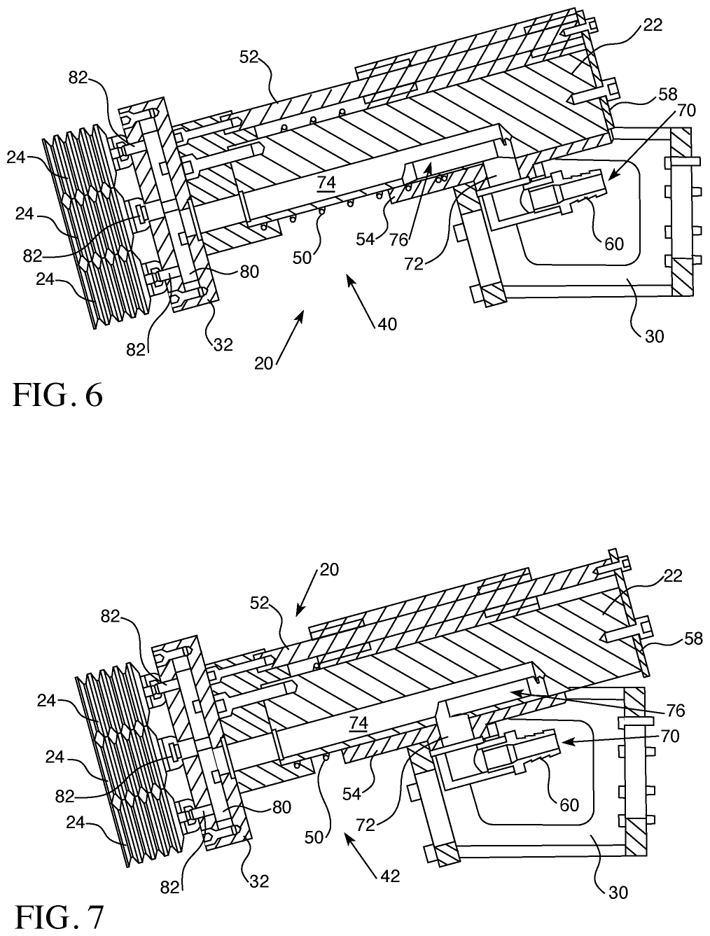

Referring to FIGS. 6 and 7, the pneumatic pathway 70 extends from the pneumatic connectors 60, through an opening 72 in a sidewall of the compensator sleeve 54, through the extendable member 22, to the cup frame 32 and vacuum cups 24 without any resilient tubes or the like extending therebetween. For example, an elongate pneumatic chamber 74 is received within the extendable member 22, and it extends from an elongate opening 76 in a sidewall of the extendable member 22 to the distal end of the extendable member. The elongate opening 76 in the extendable member sidewall is in fluid communication with the opening 72 extending through the compensator sleeve 54. Accordingly, the elongate pneumatic chamber 74 remains in pneumatic communication with the compensator sleeve opening 72 throughout the range of motion of the extendable member 22. When the extendable member 22 is in the fully extended position, as shown in FIG. 6, a proximal portion of the elongate opening 76 is in communication with the opening 72 in the compensator sleeve 54. When the extendable member 22 is in the fully retracted position, as shown in FIG. 7, a distal portion of the elongate opening 76 is in communication with the opening 72 in the compensator sleeve 54. It can be appreciated that the elongate opening 76 maintains communication between the opening 72 in the compensator sleeve 54 and the elongate pneumatic chamber 74 whether the extendable member 22 is in the extended position 40, the retracted position 42, or any position therebetween. As such, the elongate opening 76 acts as a slip seal in the vacuum pathway. Since neither the volume nor the flow path is changed with extension or retraction of the extendable member 22, vacuum flow is not affected by the mechanical compliance of the gripping system 20. Further, the tight tolerance between the sleeve 54 and the extendable member 22 minimizes air leakage in the vacuum pathway.

At the distal end of the extendable member 22, the elongate pneumatic chamber 74 operably engages a cup frame plenum 80 in the cup frame 32. The cup frame plenum 80 is in pneumatic communication with each vacuum cup 24 through cup channels 82. Accordingly, it can be appreciated that pneumatic fluid, such as air vacuum pressure or the like, can be applied through the pneumatic connectors 60 and the pneumatic pathway 70 to each of the vacuum cups 24 throughout the entire range of motion of the extendable member 22. This prevents the pneumatic system from interfering with the movement of the extendable member 22. Moreover, the pneumatic pathway 70 to the vacuum cups 24 is protected within the extendable member 22 rather than being exposed. Having external vacuum supply lines coupled directly to the cup frame plenum 80 or to each individual cup 24 would impede or otherwise effect movement of the extendable member 22. By providing the vacuum pathway 70 inside the extendable member 22, rather than having external vacuum supply lines, interference between the pneumatic system and the extendable member 22 is avoided. As such, one of the advantages of the systems disclosed herein is that the vacuum pathway 70 is internal and thus does not interfere with the movement of the extendable member 22. Another advantage of the systems disclosed herein is that maintenance or snagging issues that may arise with external vacuum supply lines are avoided. In the vacuum gripping system 20 disclosed herein, there are no hoses or lines that need to bend or flex with the compliance of the gripper arm. Thus, compliance is achieved without significant restriction to air flow. Still another advantage of the system disclosed herein is that it is significantly lighter than the prior art systems. By eliminating the connectors for external vacuum supply lines, the weight of the system disclosed herein is much less than the weight of prior art systems. Less weight allows for faster movement without impacting safety, which in turn results in higher throughput.

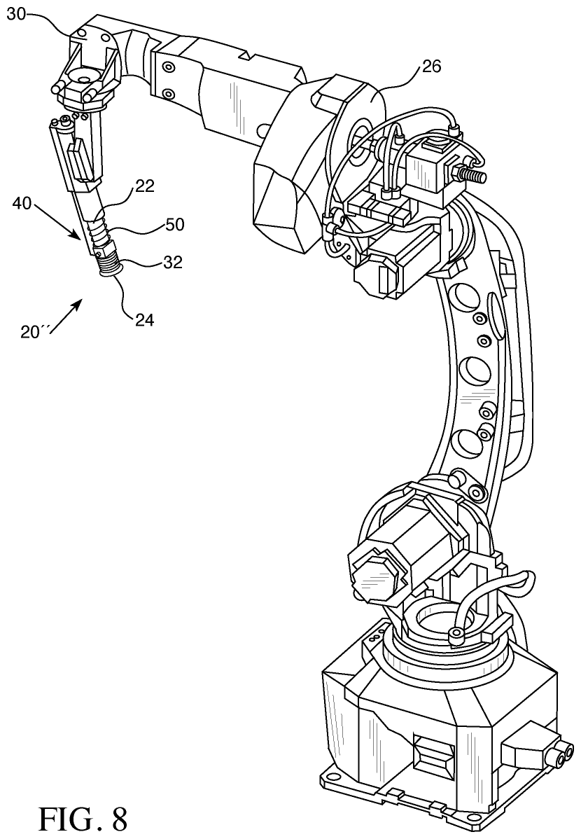

Referring to FIGS. 8-14, a pneumatic vacuum gripping system 20″ having only a single vacuum cup 24 within the cup frame 32 is depicted. The remaining components and related elements and their element numbers from the system 20 shown in FIGS. 1-7 are substantially the same. As shown in FIG. 8, the pneumatic vacuum gripping system 20″ may be operably connected to a conventional robotic arm 26 or the like. The robotic arm 26 may include servos, sensors, cameras, a pneumatic supply and related systems that allow it to locate and position the vacuum cup 24 of the pneumatic vacuum gipping system 20″ to engage an object (not shown).

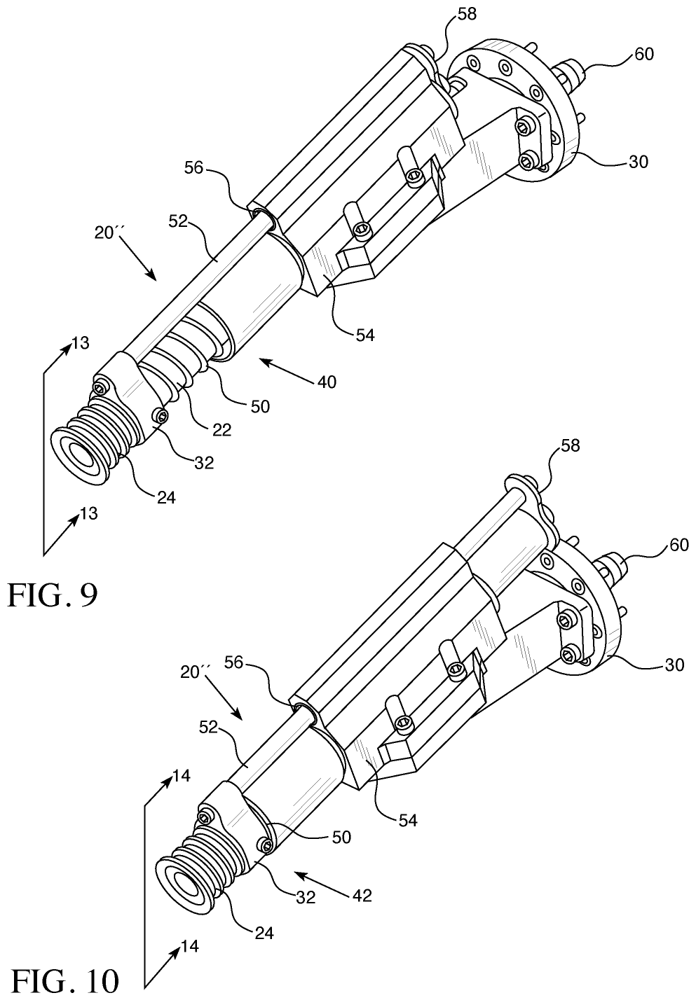

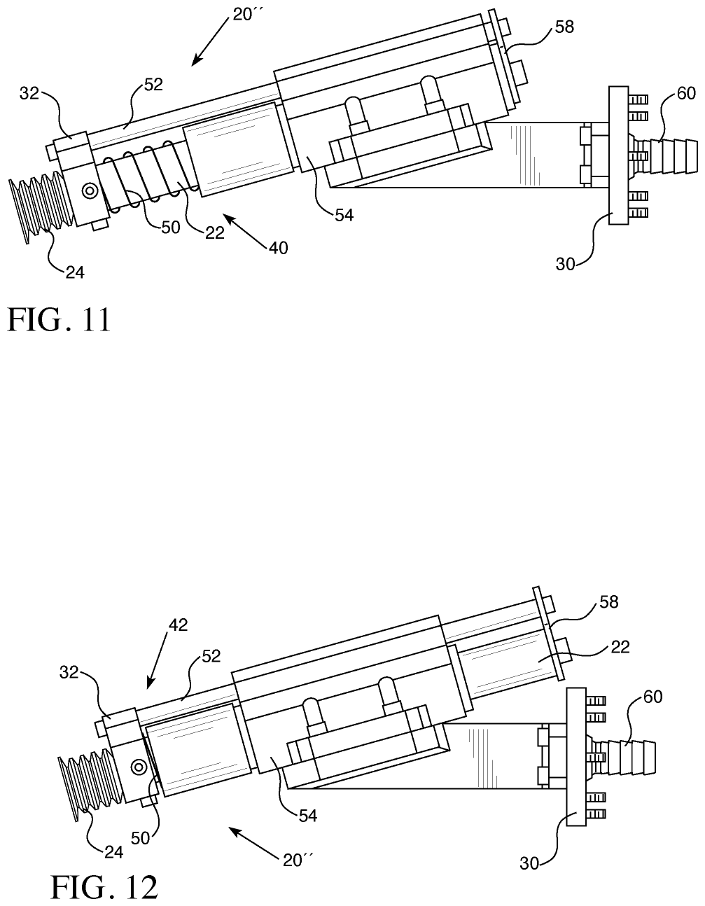

As best shown in FIGS. 9 and 10, the vacuum gripping system 20″ has a base frame 30 for operably engaging the robotic arm 26, and a single resilient vacuum cup 24 operably extending from a cup frame 32 at the distal end of the extendable member 22. The extendable member 22 is disposed between the base frame 30 and the cup frame 32. The extendable member 22 has a defined range of motion that includes an extended position 40 shown in FIGS. 8, 9, 11, and 13, and a retracted position 42 shown in FIGS. 10, 12, and 14. A biasing member 50, such as a coil spring or the like, is operably secured to the base frame 30 and the extendable member 22 to bias the extendable member 22 to its extended position 40 (FIG. 9). It can be appreciated that when the robotic arm 26 positions the vacuum cup 24 adjacent to an object to be grabbed, the extendable member 22 can retract as needed to account for positioning discrepancies and/or to limit the force asserted by the vacuum cup 24 on the object, thereby ensuring the vacuum cup 24 seals along the surface of the object to be grabbed. The biasing member 50 may be a compression spring that is biased to be in the extended position 40 and is configured to compress upon application of a small amount of force. As such, when an object is encountered, force exerted on the extendable member 22 by the object may cause the biasing member 50 to compress and the extendable member 22 to retract in order to compensate for any discrepancies in the pick point location of the object and avoid damage to the system. The load required to compress the biasing member 50 may be relatively small.

A compensation window is provided by the compression of the vacuum cup 24 and the extendable member 22. This compensation window compensates for any errors that may be present in the accuracy of the pick point location provided by the pick point selection system. The length of the compensation window is dependent upon the length of the biasing member 50. In one embodiment, spacers may be added to one or both ends of the biasing member 50 to shorten the compensation window without making any major modifications to the gripping system 20″.

The vacuum gripping system 20″ further includes a compensator sleeve 54 that surrounds the extendable member 22. The extendable member 22 translates linearly relative to the sleeve 54. The inner diameter of the compensator sleeve 54 is slightly larger than the outer diameter of the extendable member 22. In one example, the inner diameter of the compensator sleeve 54 may be no more than 0.1 mm larger than the outer diameter of the extendable member 22. In another example, the compensator sleeve 54 includes bushings on both ends to reduce the clearance between the compensator sleeve 54 and the extendable member 22. The tight clearance between the sleeve 54, or the sleeve bushings, and the extendable member 22 reduces air leakage in the vacuum pathway. The extendable member 22, compensator sleeve 54, and/or the bushings on both ends of the compensator sleeve 54 may be made from, or coated with, a low friction material.

If desired, a second retractable sliding alignment member 52 may be parallelly-aligned and positioned adjacent to the extendable member 22 to ensure smooth movement of the extendable member 22 along its defined range of motion and control the rotational orientation of the extendable member 22. The sliding alignment member 52 is disposed in an opening 56 in the compensator sleeve 54. A plate 58 attached to a proximal end of the extendable member 22 and the alignment member 52 acts as an end stop to prevent the extendable member 22 and the alignment member 52 from extending into the sleeve 54.

As best shown in FIGS. 11 and 12, the base frame 30 may include a pneumatic connector 60 for connecting a pneumatic supply line to the system 20″. This pneumatic supply line delivers and removes vacuum pressure to the vacuum cup 24 via an internal pneumatic pathway (discussed in greater detail below) based on predetermined criteria which may include information from pressure and other sensors and cameras operably secured to the robotic system, thereby allowing the vacuum cup 24 to operably grip and hold the object for movement by the robot 26 and then release the object after it has been moved.

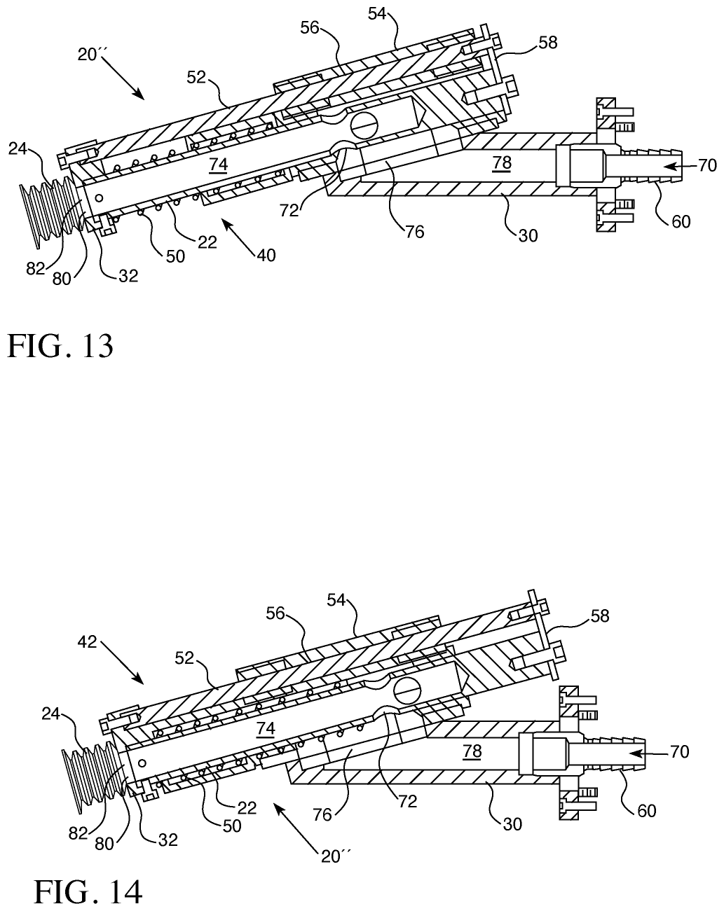

It should be noted that one difference between the system 20″ and the system 20 shown in FIGS. 1-7 is that the opening 72 and the elongate opening 76 in the pneumatic pathway are in different positions compared to the previous embodiment. In particular, with reference to FIGS. 13 and 14, the opening 72 is in the sidewall of the extendable member 22, but is in the sidewall of the compensator sleeve 54 in the system 20 shown in FIGS. 1-7. Further, the elongate opening 76 is in the sidewall of the compensator sleeve 54 in the system 20″, but is in the sidewall of the extendable member 22 in the previous system 20. As shown in FIGS. 13 and 14, the internal vacuum pathway of the system 20″ includes a base frame channel 78, an elongate opening 76 in the compensator sleeve 54, an opening 72 in the extendable member 22, the elongate pneumatic chamber 74 in the extendable member 22, a cup frame plenum 80 in the cup frame 32, and a cup channel 82 in pneumatic communication with the vacuum cup 24.

Referring to FIGS. 13 and 14, the pneumatic pathway 70 extends from the pneumatic connector 60, through the elongate opening 76 in the compensator sleeve 54, through the extendable member 22, to the cup frame 32 and vacuum cup 24 without any resilient tubes or the like extending therebetween. For example, an elongate pneumatic chamber 74 is received within the extendable member 22, and it includes an opening 72 to operably engage the elongate opening 76 extending through the compensator sleeve 54. Accordingly, the elongate pneumatic chamber 74 remains in pneumatic communication with the compensator sleeve elongate opening 76 throughout the range of motion of the extendable member 22. When the extendable member 22 is in the fully extended position, as shown in FIG. 13, a distal portion of the elongate opening 76 is in communication with the opening 72 in the pneumatic chamber 74. When the extendable member 22 is in the fully retracted position, as shown in FIG. 14, a proximal portion of the elongate opening 76 is in communication with the opening 72 in the pneumatic chamber 74. It can be appreciated that the elongate opening 76 maintains communication between the opening 72 in the pneumatic chamber 74 and the base frame channel 78 whether the extendable member 22 is in the extended position 40, the retracted position 42, or any position therebetween. As such, the elongate opening 76 acts as a slip seal in the vacuum pathway. Since neither the volume nor the flow path is changed with extension or retraction of the extendable member 22, vacuum flow is not affected by the mechanical compliance of the gripping system 20. Further, the tight tolerance between the sleeve 54 and the extendable member 22 eliminates or minimizes air leakage in the vacuum pathway 70.

At the distal end of the extendable member 22, the elongate pneumatic chamber 74 operably engages a cup frame plenum 80 in the cup frame 32. The cup frame plenum 80 is in pneumatic communication with the vacuum cup 24 through a cup channel 82. Accordingly, it can be appreciated that pneumatic fluid, such as air vacuum pressure or the like, can be applied through the pneumatic connectors 60 and the pneumatic pathway 70 to the vacuum cup 24 throughout the entire range of motion of the extendable member 22. This prevents the pneumatic system from interfering with the movement of the extendable member 22. Moreover, the pneumatic pathway 70 to the vacuum cup 24 is protected within the extendable member 22 rather than being exposed. Having external vacuum supply lines coupled directly to the cup frame plenum 80 or to the vacuum cup 24 would impede or otherwise effect movement of the extendable member 22. By providing the vacuum pathway 70 inside the extendable member 22, rather than having external vacuum supply lines, interference between the pneumatic system and the extendable member 22 is avoided. As such, one of the advantages of the systems disclosed herein is that the vacuum pathway 70 is internal and thus does not interfere with the movement of the extendable member 22. Another advantage of the systems disclosed herein is that maintenance or snagging issues that may arise with external vacuum supply lines are avoided. In the vacuum gripping system 20″ disclosed herein, there are no hoses or lines that need to bend or flex with the compliance of the gripper arm. Thus, compliance is achieved without significant restriction to air flow. Still another advantage of the system disclosed herein is that it is significantly lighter than the prior art systems. By eliminating the connectors for external vacuum supply lines, the weight of the system disclosed herein is much less than the weight of prior art systems. Less weight results in higher throughput.

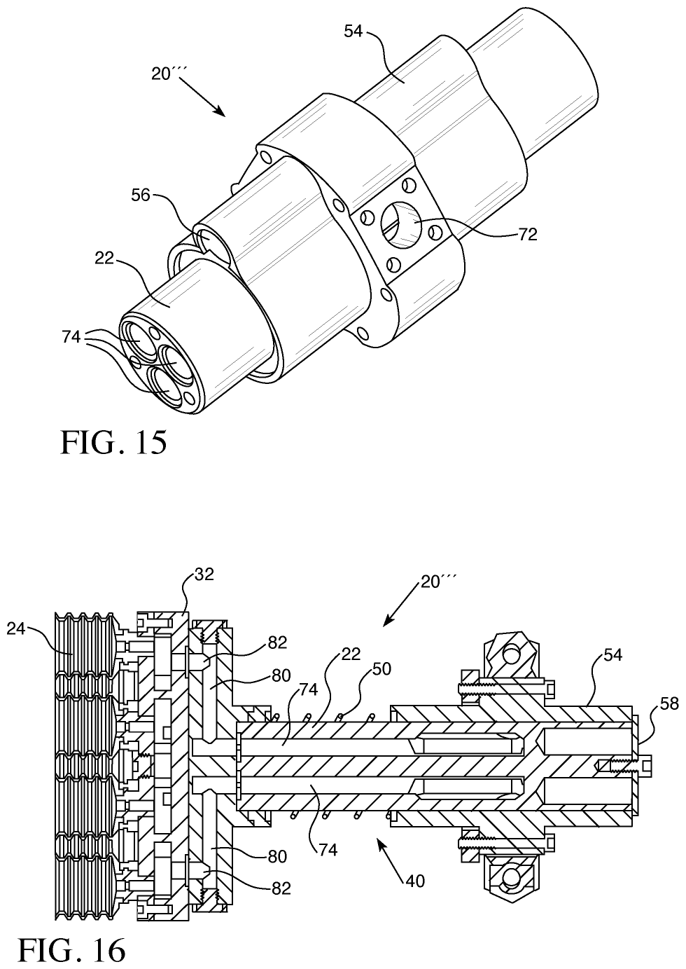

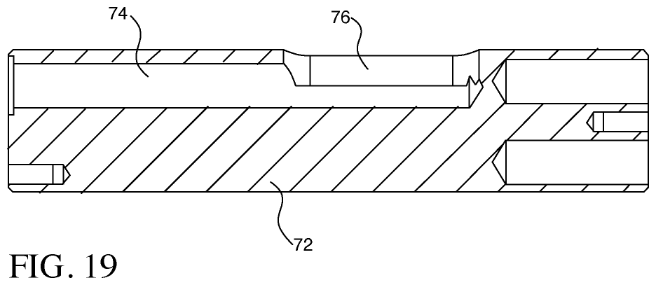

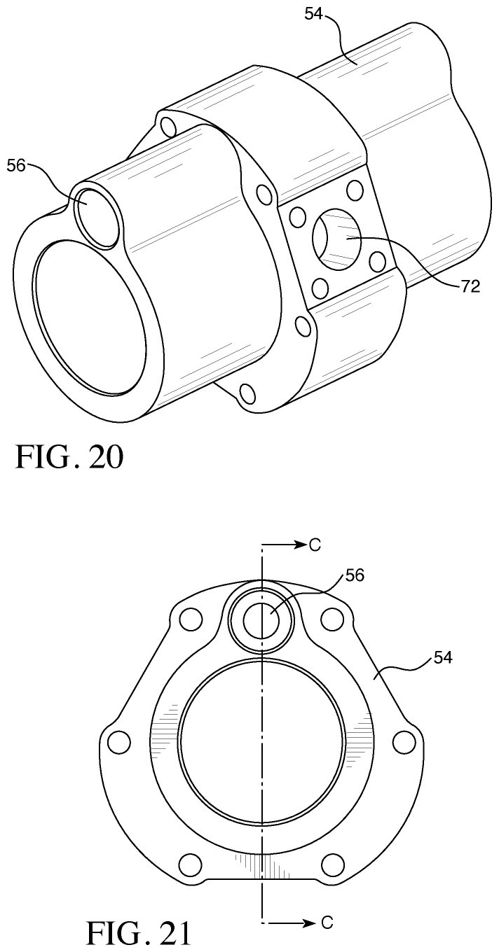

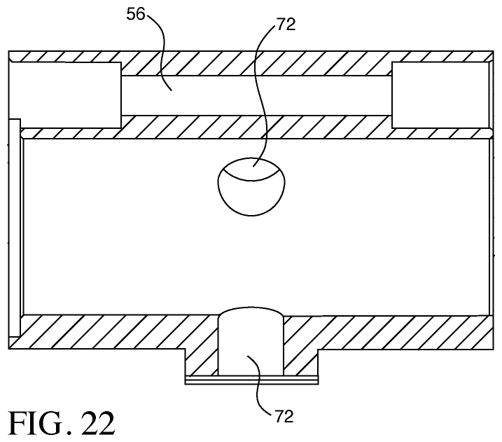

FIGS. 15-22 depict a pneumatic vacuum gripping system 20′″ that includes three pneumatic chambers 74 and each one of the pneumatic chambers 74 is in communication with a different group of vacuum cups 24. In contrast, the system 20 shown in FIGS. 1-7 includes one pneumatic chamber 74 in communication with all of the vacuum cups 24 in the array. The remaining components and related elements and their element numbers from the previous system 20 are substantially the same. In the system 20′″ shown in FIGS. 15-22, the array of vacuum cups 24 is divided into zones with each zone being in communication with a separate pneumatic chamber 74. As such, each zone of vacuum cups 24 is separately controlled and one, two, or all three zones may be activated, depending on the size of the object to be picked. It will be readily apparent to one of ordinary skill in the art that the gripping system 20′″ is not limited to three vacuum cup zones and three pneumatic chambers. The vacuum cups 24 may be divided into 2, 4, 5, 6, 7, 8, or more zones, with each zone having a pneumatic chamber 74 in communication therewith.

For example, with reference to the vacuum cup array 24 depicted in FIGS. 2 and 3, one of the pneumatic channels 74 may be in communication with the top row of three vacuum cups 24, another one of the pneumatic channels 74 may be in communication with the middle row of four vacuum cups 24, and the third pneumatic channel 74 may be in communication with the bottom row of three vacuum cups 24. It will be readily apparent to one of ordinary skill in the art that the vacuum cups 24 may be divided into more or fewer zones and that the zones may have any desired arrangement. For example, the three vacuum cups 24 on the right side of the array may be one zone, the middle four cups 24 of the array may be a second zone, and the three vacuum cups 24 on the left side of the array may be a third zone. When the vision system associated with the gripper arm determines that the object to be picked is smaller than the array of vacuum cups 24, one or two of the vacuum cup zones may be turned off. The remaining activated vacuum cup zone(s) are used to pick the object and air leakage is avoided.

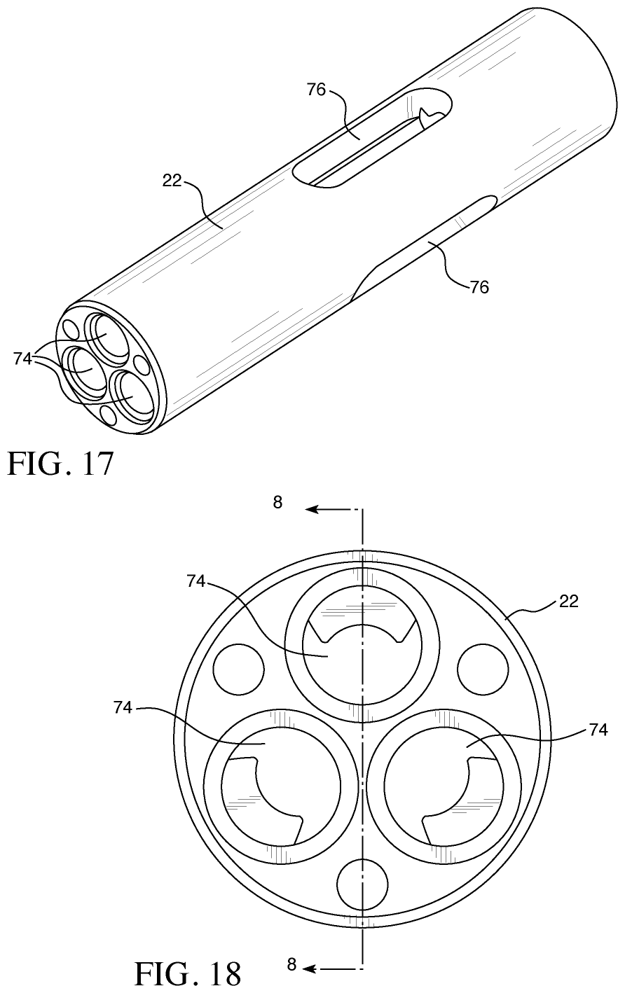

As best shown in FIGS. 15 and 16, the vacuum gripping system 20′″ includes an extendable member 22 and a compensator sleeve 54 surrounding the extendable member 22. The extendable member 22 translates linearly relative to the sleeve 54. The inner diameter of the compensator sleeve 54 is slightly larger than the outer diameter of the extendable member 22. In one example, the inner diameter of the compensator sleeve 54 may be no more than 0.1 mm larger than the outer diameter of the extendable member 22. In another example, the compensator sleeve 54 includes bushings on both ends to reduce the clearance between the compensator sleeve 54 and the extendable member 22. The tight clearance between the sleeve 54, or the sleeve bushings, and the extendable member 22 reduces air leakage in the vacuum pathway. The extendable member 22, compensator sleeve 54, and/or the bushings on both ends of the compensator sleeve 54 may be made from, or coated with, a low friction material.

In the previous system 20, depicted in FIGS. 1-7, the extendable member 22 includes only one pneumatic chamber 74 in communication with all of the vacuum cups 24. In the system 20′″ depicted in FIGS. 15-22, the extendable member 22 includes three pneumatic chambers 74 and each one of the pneumatic chambers 74 is in communication with a group of vacuum cups 24. In this manner, the array of vacuum cups 24 is divided into zones and each zone may be activated or deactivated. For example, if the robotic vision system determines that the object to be picked is smaller than the array of vacuum cups 24, one or two of the zones may be deactivated so that the object may be picked by fewer vacuum cups 24, thereby avoiding air leakage through the vacuum cups 24 that do not contact the object. In this embodiment, each one of the pneumatic connectors 60 (depicted in FIGS. 4-7) is in communication with one of the pneumatic chambers 74 and is connected to a controller for activating or deactivating the vacuum pathway to the group of vacuum cups 24.

The compensator sleeve 54 may include an elongate opening 56 for housing the sliding alignment member 52. The compensator sleeve 54 may further include openings 72 in a sidewall thereof that provide a vacuum pathway between the connectors 60 and the pneumatic channels 74 in the extendable member 22. In this embodiment, there are three compensator sleeve openings 72 in the sidewall of the compensator sleeve 54, each opening 72 in communication with one of the respective three pneumatic chambers 74 in the extendable member 22 and one of the respective three pneumatic connectors 60.

As best shown in FIG. 16, a biasing member 50, such as a coil spring or the like, is operably secured around the extendable member 22 between the compensator sleeve 54 and the vacuum cup array 24 to bias the extendable member 22 to its extended position 40. It can be appreciated that when the robotic arm 26 (depicted in FIG. 1) positions a vacuum cup 24 adjacent to an object to be grabbed, the extendable member 22 can retract as needed so as to account for positioning discrepancies and/or to limit the force asserted by the vacuum cup 24 on the object, thereby ensuring the vacuum cup 24 seals along the surface of the object to be grabbed. The seal between the vacuum cups 24 and the object can only be achieved if air leakage is eliminated or minimized. As such, this system 20′″ is advantageous for picking objects that may be smaller than the array of vacuum cups 24 because the vacuum cups 24 that do not contact the object can be turned off.

The biasing member 50 may be a compression spring that is biased to be in the extended position 40 and is configured to compress upon application of a small amount of force. As such, when an object is encountered, force exerted on the extendable member 22 by the object may cause the biasing member 50 to compress and the extendable member 22 to retract in order to compensate for any discrepancies in the pick point location of the object and avoid damage to the system. The load required to compress the biasing member 50 may be relatively small. A compensation window is provided by the compression of the vacuum cup 24 and the extendable member 22. This compensation window compensates for any errors that may be present in the accuracy of the pick point location provided by the pick point selection system. A plate 58 attached to a proximal end of the extendable member 22 acts as an end stop to prevent the extendable member 22 and the alignment member 52 from extending into the sleeve 54. Although the sliding alignment member 52 is not depicted in FIG. 16, it will be readily apparent to one of ordinary skill in the art that the embodiment depicted in FIG. 16 may further include the sliding alignment member 52, similar to previous embodiments described herein.

FIG. 16 depicts two of the pneumatic channels 74 in the extendable member 22. Each one of the pneumatic channels 74 is coupled to a group of the vacuum cups 24. At the distal end of the extendable member 22, each one of the elongate pneumatic chambers 74 operably engages a respective cup frame plenum 80 in the cup frame 32. Each cup frame plenum 80 is in pneumatic communication with a group of vacuum cups 24 through a respective cup channel 82. Accordingly, it can be appreciated that pneumatic fluid, such as air vacuum pressure or the like, can be applied through the pneumatic connectors 60 and the pneumatic pathway 70 to each of the vacuum cups 24 throughout the entire range of motion of the extendable member 22. This prevents the pneumatic system from interfering with the movement of the extendable member 22. Moreover, the pneumatic pathway 70 to the vacuum cups 24 is protected within the extendable member 22 rather than being exposed. Having external vacuum supply lines coupled directly to the cup frame plenum 80 or to each individual cup 24 would impede or otherwise effect movement of the extendable member 22. By providing vacuum pathways inside the extendable member 22, rather than having external vacuum supply lines, interference between the pneumatic system and the extendable member 22 is avoided. As such, one of the advantages of the systems disclosed herein is that the vacuum pathways are internal and thus do not interfere with the movement of the extendable member 22. Another advantage of the systems disclosed herein is that maintenance or snagging issues that may arise with external vacuum supply lines are avoided. There are no hoses or lines that need to bend or flex with the compliance of the gripper arm. Thus, compliance is achieved without significant restriction to air flow. Air leakage is avoided by having tight clearance between the extendable arm 22 and the sleeve 54. Still another advantage of the system disclosed herein is that it is significantly lighter than the prior art systems. By eliminating the connectors for external vacuum supply lines, the weight of the system disclosed herein is much less than the weight of prior art systems. Less weight results in higher throughput.

When the vacuum gripping system 20′″ is coupled to a base frame, such as the base frame 30 shown in FIGS. 1-7, each one of the pneumatic connectors 60 is in communication with one of the pneumatic channels 74 through one of the openings 72 in the compensator sleeve 54. The pneumatic pathway 70 extends from the pneumatic connectors 60, through an opening 72 in the compensator sleeve 54, through the extendable member 22, to the cup frame 32 and vacuum cups 24 without any resilient tubes or the like extending therebetween. For example, the elongate pneumatic chambers 74 within the extendable member 22 are in fluid communication with elongate openings 76 in the sidewall of the extendable member 22 (shown in FIG. 17) to operably engage the openings 72 extending through the compensator sleeve 54. Accordingly, the elongate pneumatic chambers 74 remain in pneumatic communication with the compensator sleeve openings 72 throughout the range of motion of the extendable member 22. When the extendable member 22 is in the fully extended position, a proximal portion of each one of the elongate openings 76 is in communication with the associated opening 72 in the compensator sleeve 54. When the extendable member 22 is in the fully retracted position, a distal portion of each one of the elongate openings 76 is in communication with the associated opening 72 in the compensator sleeve 54. It can be appreciated that the elongate openings 76 maintain communication between the openings 72 in the compensator sleeve 54 and the elongate pneumatic chambers 74 whether the extendable member 22 is in the extended position 40, the retracted position 42, or any position therebetween. As such, the elongate openings 76 act as a slip seal in the vacuum pathways. The tight tolerance between the sleeve 54 and the extendable member 22 minimizes air leakage.

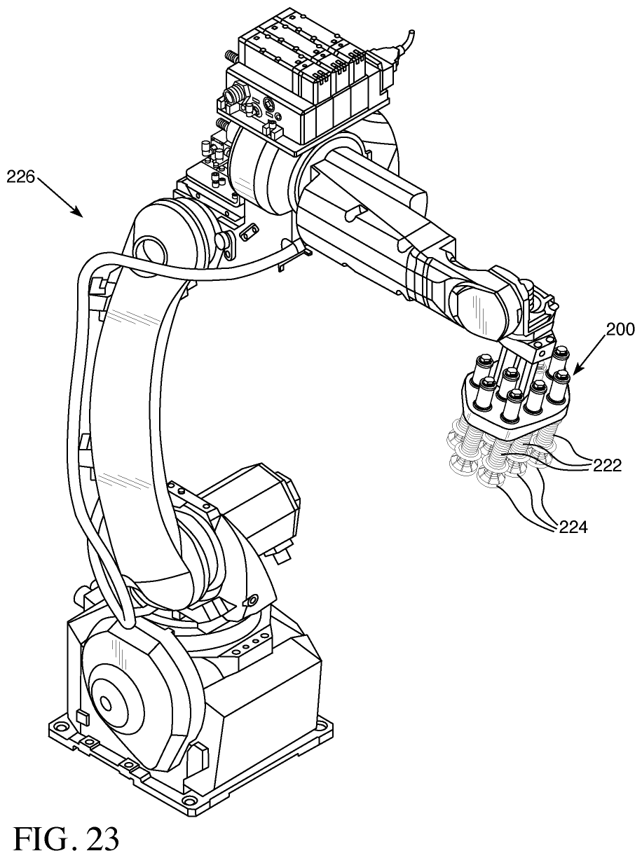

In another example of a vacuum gripping system 200, depicted in FIGS. 23-27, each vacuum cup 224 is coupled to its own extendable arm 222. This vacuum gripping system 200 also includes multiple vacuum channels, similar to the system 20′″ in FIGS. 15-22. With the plurality of vacuum cups 224 and extendable arms 222, this embodiment 200 is advantageous for picking objects that have curved surfaces where some of the vacuum cups 224 may compress more than the others.

As shown in FIG. 23, the pneumatic vacuum gripping system 200 may be operably connected to a conventional robotic arm 226 or the like. The robotic arm 226 may include servos, sensors, cameras, a pneumatic supply and related systems that allow it to locate and position one or more vacuum cups 224 of the pneumatic vacuum gipping system 200 to engage an object (not shown).

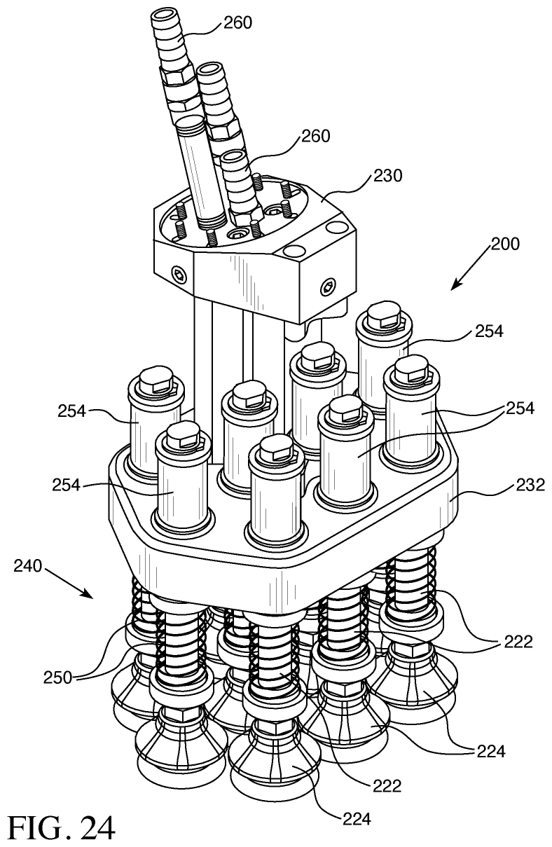

As best shown in FIG. 24, the vacuum gripping system 200 may have a base frame 230 for operably engaging the robotic arm 226, and a plurality of resilient vacuum cups 224 operably coupled to a distribution block 232. The extendable members 222 are configured to retract relative to the distribution block 232. The extendable members 222 have a defined range of motion that includes an extended position 240 shown in FIG. 24 and a retracted position. Biasing members 250, such as coil springs or the like, are operably secured to the distribution block 232 and the extendable members 222 to bias the extendable members 222 to the extended position 240 (FIG. 24). It can be appreciated that when the robotic arm 226 positions a vacuum cup 224 adjacent to an object to be grabbed, the extendable members 222 can retract as needed to account for positioning discrepancies and/or to limit the force asserted by the vacuum cups 224 on the object, thereby ensuring the vacuum cups 224 seal along the surface of the object to be grabbed. Since each of the extendable members 222 is configured to move axially relative to the distribution block 232 independent of the other extendable members 222, the gripping system 200 is particularly advantageous for use with objects having curved surfaces. The biasing members 250 may be compression springs that are biased to be in the extended position 240 and are configured to compress upon application of a small amount of force. As such, when an object is encountered, force exerted on the extendable members 222 by the object may cause the biasing members 250 to compress and the extendable members 222 to retract in order to compensate for any discrepancies in the pick point location of the object and avoid damage to the system. Further, each one of the extendable members 222 is able to compress by a different amount to account for any curvature in the surface of the object. Depending on the shape of the object, some of the extendable members 222 may compress completely, some of the extendable members 222 may compress slightly or not at all, and some of the extendable members 222 may compress to a position that is between fully extended and fully compressed. The load required to compress the biasing members 250 may be relatively small. A compensation window is provided by the compression of the vacuum cups 224 and the extendable members 222. This compensation window compensates for any errors that may be present in the accuracy of the pick point location provided by the pick point selection system and compensates for any curvature in the surface of the object. The length of the compensation window is dependent upon the length of the biasing members 250. In one embodiment, spacers may be added to one or both ends of the biasing members 250 to shorten the compensation window without making any major modifications to the gripping system 200.

The vacuum gripping system 200 may further include a plurality of compensator sleeves 254 that surround the respective plurality of extendable members 222. The extendable members 222 translate linearly relative to the sleeves 254, and the sleeves 254 are fixed relative to the distribution block 232. The inner diameter of the compensator sleeves 254 is slightly larger than the outer diameter of the extendable members 222. In one example, the inner diameter of the compensator sleeves 254 may be no more than 0.1 mm larger than the outer diameter of the extendable members 222. In another example, the compensator sleeves 254 include bushings on both ends to reduce the clearance between the compensator sleeves 254 and the extendable members 222. The tight clearance between the sleeves 254 and the extendable members 222 reduces air leakage in the vacuum pathway. The extendable members 222, compensator sleeves 254, and/or the bushings on both ends of the compensator sleeves 254 may be made from, or coated with, a low friction material.

The base frame 230 includes pneumatic connectors 260 for connecting pneumatic supply lines to the system 200. This pneumatic supply line delivers and removes vacuum pressure to the vacuum cups 224 based on predetermined criteria which may include information from pressure and other sensors and cameras operably secured to the robotic system, thereby allowing the vacuum cups 224 to operably grip and hold the object for movement by the robot 226 and then release the object after it has been moved.

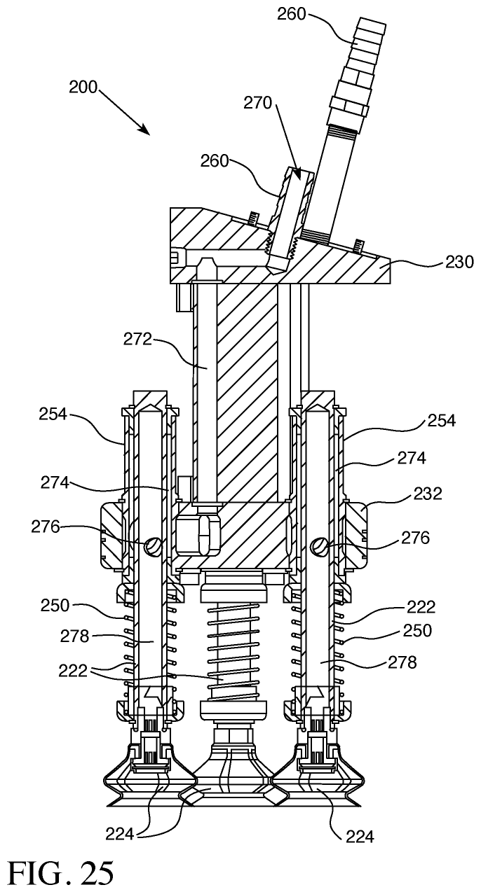

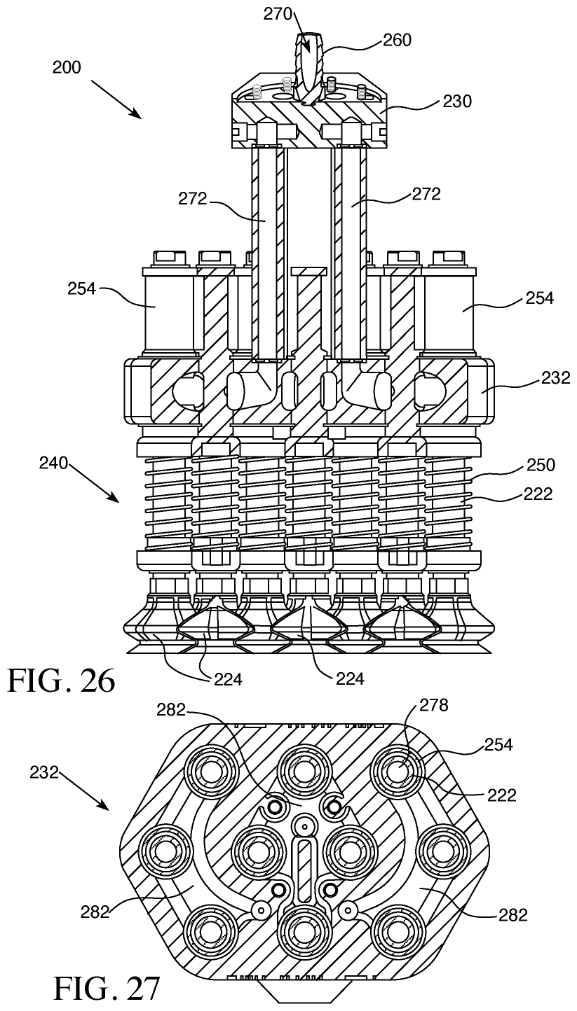

Referring to FIGS. 25 and 26, the system 200 includes three separate pneumatic pathways 270, each pathway 270 being coupled to one of the pneumatic connectors 260 and to a zone of the vacuum cup array. Each pathway 270 extends from one of the pneumatic connectors 260, through a pneumatic channel 272 in the base frame 230, an elongated opening 274 in the sidewall of the compensator sleeve 254, an opening 276 in the sidewall of the extendable member 222, and a channel 278 through the extendable member 222, to the vacuum cup 224 at the distal end of the extendable member 222 without any resilient tubes or the like extending therebetween. For example, the channel 278 in the extendable member 222 is in communication with the opening 276 to operably engage the elongated opening 274 extending through the sidewall of the compensator sleeve 254. Accordingly, the extendable member channel 278 remains in pneumatic communication with the compensator sleeve opening 274 throughout the range of motion of the extendable member 222. When the extendable member 222 is in the fully extended position, as shown in FIGS. 23-26, a distal portion of the elongated opening 274 is in communication with the opening 276 in the extendable member 222. When the extendable member 222 is in the fully retracted position, a proximal portion of the elongate opening 274 is in communication with the opening 276 in the extendable member 222. In this manner, the configuration of each one of the extendable members 222 and the compensator sleeves 254 is similar to the system 20″ in FIGS. 8-14 wherein the elongated opening 76 is disposed in the compensator sleeve 54 and is in communication with an opening 78 in the extendable member 22 (see FIGS. 13 and 14). It can be appreciated that the elongate opening 274 maintains communication between the opening 276 in the extendable member 222 and the channel 272 in the base frame 230 whether the extendable member 222 is in the extended position 240, the retracted position 242, or any position therebetween. As such, the elongate opening 274 acts as a slip seal in the vacuum pathway 270. Since neither the volume nor the flow path is changed with extension or retraction of the extendable member 222, vacuum flow is not affected by the mechanical compliance of the gripping system 200. Further, the tight tolerance between the sleeve 254 and the extendable member 222 minimizes air leakage in the vacuum pathway 270.

In the vacuum gripping system 200, the array of vacuum cups 224 is divided into zones with each zone being in communication with a separate pneumatic channel 272. As such, each zone of vacuum cups 224 is separately controlled and one, two, or all three zones may be activated, depending on the size of the object to be picked. It will be readily apparent to one of ordinary skill in the art that the gripping system 200 is not limited to three vacuum cup zones and three pneumatic channels. The vacuum cups 224 may be divided into 2, 4, 5, 6, 7, 8, or more zones, with each zone having a pneumatic channel in communication therewith.

FIG. 27 depicts the distribution block 232 in more detail. The distribution block 232 is divided into three vacuum zones 282. Each one of the pneumatic channels 272 in the base frame 230 is in communication with one of the vacuum zones 282. In this example, the three extendable arms 222 on the right side of the array are in one of the vacuum zones 282, the three extendable arms 222 on the left side of the array are in another vacuum zone 282, and the four extendable arms 222 in the middle of the array are in another vacuum zone 282. It will be readily apparent to one of ordinary skill in the art that the vacuum cups 224 may be divided into more or fewer zones and that the zones may have any desired arrangement. For example, the three vacuum cups 224 on the top of the array may be one zone, the middle row of four cups 224 of the array may be a second zone, and the three vacuum cups 224 on the bottom of the array may be a third zone. When the vision system associated with the gripper arm determines that the object to be picked is smaller than the array of vacuum cups 224, one or two of the vacuum cup zones may be turned off. The remaining activated vacuum cup zone(s) are used to pick the object and air leakage is avoided.

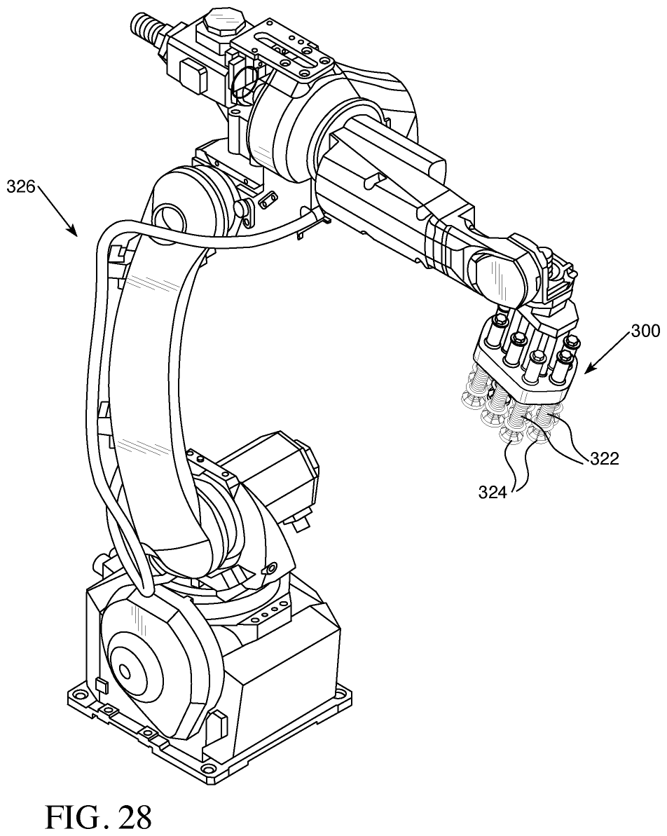

The system 300 depicted in FIGS. 28-32 is substantially similar to the system 200 depicted in FIGS. 23-27, except that there is a single vacuum channel rather than multiple vacuum channels. As such, the vacuum cups 324 are all coupled to a single vacuum source and the vacuum cups 324 in the array are not divided into separately controllable zones.

Similar to the previous system 200, the gripping system 300 includes a plurality of vacuum cups 324, and each vacuum cup 324 is coupled to its own extendable arm 322. With the plurality of vacuum cups 324 and extendable arms 322, this embodiment 300 is advantageous for picking objects that have curved surfaces where some of the vacuum cups 324 may need to compress more than the others.

As shown in FIG. 28, the pneumatic vacuum gripping system 300 may be operably connected to a conventional robotic arm 326 or the like. The robotic arm 326 may include servos, sensors, cameras, a pneumatic supply and related systems that allow it to locate and position one or more vacuum cups 324 of the pneumatic vacuum gipping system 300 to engage an object (not shown).

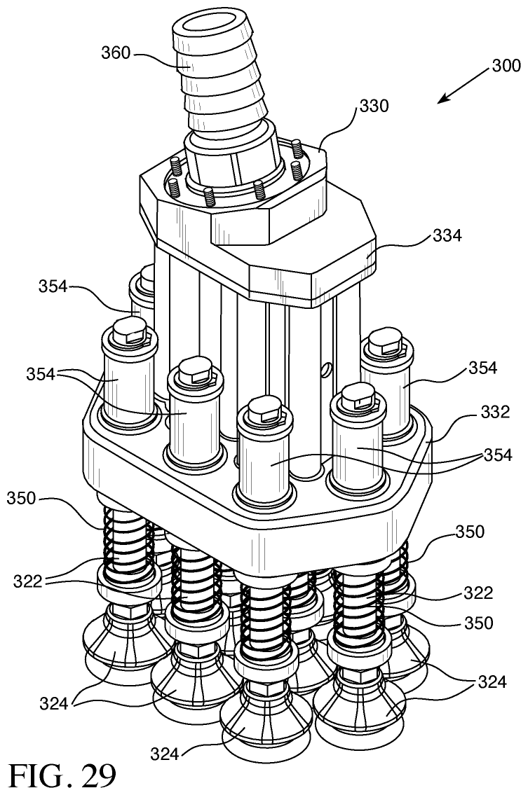

As best shown in FIG. 29, the vacuum gripping system 300 has a base frame 330 for operably engaging the robotic arm 326, and a plurality of resilient vacuum cups 324 operably coupled to a distribution block 332. The extendable members 322 are configured to retract relative to the distribution block 332. The extendable members 322 have a defined range of motion that includes an extended position shown in FIG. 29 and a retracted position. Biasing members 350, such as coil springs or the like, are operably secured to the distribution block 332 and the extendable members 322 to bias the extendable members 322 to the extended position. It can be appreciated that when the robotic arm 326 positions a vacuum cup 324 adjacent to an object to be grabbed, the extendable members 322 can retract as needed to account for positioning discrepancies and/or to limit the force asserted by the vacuum cups 324 on the object, thereby ensuring the vacuum cups 324 seal along the surface of the object to be grabbed. Since each of the extendable members 322 is configured to move axially relative to the distribution block 332 independent of the other extendable members 322, the gripping system 300 is particularly advantageous for use with objects having curved surfaces. The biasing members 350 may be compression springs that are biased to be in the extended position and are configured to compress upon application of a small amount of force. As such, when an object is encountered, force exerted on the extendable members 322 by the object may cause the biasing members 350 to compress and the extendable members 322 to retract in order to compensate for any discrepancies in the pick point location of the object and avoid damage to the system. Further, each one of the extendable members 322 is able to compress by a different amount to account for any curvature in the surface of the object. Depending on the shape of the object, some of the extendable members 322 may compress completely, some of the extendable members 322 may compress slightly or not at all, and some of the extendable members 322 may compress to a position that is between fully extended and fully compressed. The load required to compress the biasing members 350 may be relatively small.

A compensation window is provided by the compression of the vacuum cups 324 and the extendable members 322. This compensation window compensates for any errors that may be present in the accuracy of the pick point location provided by the pick point selection system and compensates for any curvature in the surface of the object. The length of the compensation window is dependent upon the length of the biasing members 350. In one embodiment, spacers may be added to one or both ends of the biasing members 350 to shorten the compensation window without making any major modifications to the gripping system 300.

The vacuum gripping system 300 may further include a plurality of compensator sleeves 354 that surround the respective plurality of extendable members 322. The extendable members 322 translate linearly relative to the sleeves 354. The inner diameter of the compensator sleeves 354 is slightly larger than the outer diameter of the extendable members 322. In one example, the inner diameter of the compensator sleeves 354 may be no more than 0.1 mm larger than the outer diameter of the extendable members 322. In another example, the compensator sleeves 354 include bushings on both ends to reduce the clearance between the compensator sleeves 354 and the extendable members 322. The tight clearance between the sleeves 354 and the extendable members 322 reduces air leakage in the vacuum pathway. The extendable members 322, compensator sleeves 354, and/or the bushings on both ends of the compensator sleeves 354 may be made from, or coated with, a low friction material.

The base frame 330 includes a pneumatic connector 360 for connecting a pneumatic supply line to the system. This pneumatic supply line delivers and removes vacuum pressure to the vacuum cups 324 based on predetermined criteria which may include information from pressure and other sensors and cameras operably secured to the robotic system, thereby allowing the vacuum cups 324 to operably grip and hold the object for movement by the robot 326 and then release the object after it has been moved.

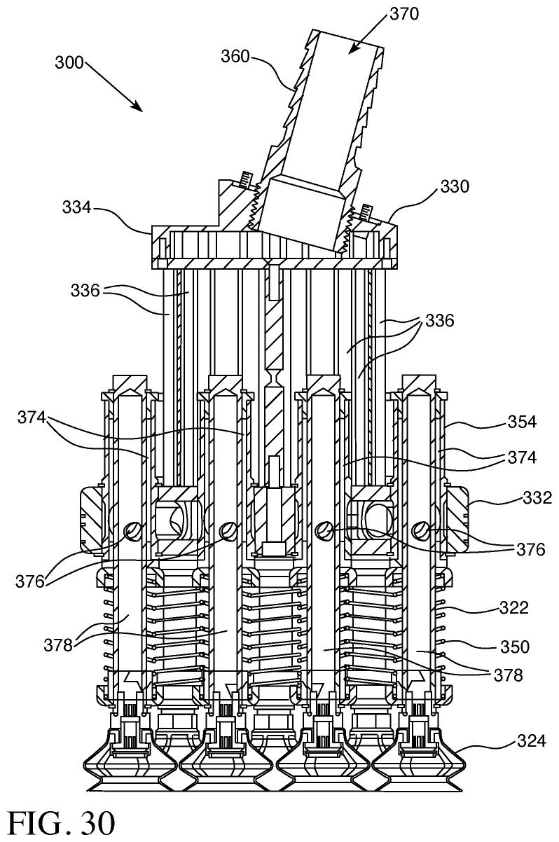

Referring to FIG. 30, the pneumatic connector 360 is coupled to an upper distribution block 334 configured for distributing the vacuum pressure amongst a plurality of pneumatic channels 336. The upper distribution block 334 is shown in cross-section in FIG. 31. The pneumatic pathway 370 of this system 300 extends from the pneumatic connector 360, through the upper distribution block 334, pneumatic channels 336 in the base frame 330, elongated openings 374 in the compensator sleeves 354, openings 376 in the extendable member 322, and channels 378 through the extendable member 322, to the vacuum cups 324 at the distal end of the extendable member 322 without any resilient tubes or the like extending therebetween. For example, the channel 378 in the extendable member 322 is in communication with the opening 376 to operably engage the elongated opening 374 extending through the compensator sleeve 354. In this manner, the configuration of each one of the extendable members 322 and the compensator sleeves 354 is similar to the system 20″ wherein the elongated opening 76 is disposed in the compensator sleeve 54 and is in communication with an opening 78 in the extendable member 22 (see FIGS. 13 and 14). Accordingly, the extendable member channel 378 remains in pneumatic communication with the compensator sleeve opening 374 throughout the range of motion of the extendable member 322. When the extendable member 322 is in the fully extended position, as shown in FIGS. 28-30, a distal portion of the elongated opening 374 is in communication with the opening 376 in the extendable member 322. When the extendable member 322 is in the fully retracted position, a proximal portion of the elongate opening 374 is in communication with the opening 376 in the extendable member 322. It can be appreciated that the elongate opening 374 maintains communication between the opening 376 in the extendable member 322 and the channel 336 in the base frame 330 whether the extendable member 322 is in the extended position, the retracted position, or any position therebetween. As such, the elongate opening 374 acts as a slip seal in the vacuum pathway. Since neither the volume nor the flow path is changed with extension or retraction of the extendable member 322, vacuum flow is not affected by the mechanical compliance of the gripping system 300. Further, the tight tolerance between the sleeve 354 and the extendable member 322 eliminates or minimizes air leakage in the vacuum pathway.

In the vacuum gripping system 300, each vacuum cup 324 in the array of vacuum cups 324 is in communication with the single pneumatic connector 360. As such, the vacuum cups 324 are not divided into separately controlled vacuum zones, but rather, the vacuum pressure is applied to all of the vacuum cups 324 in the array.

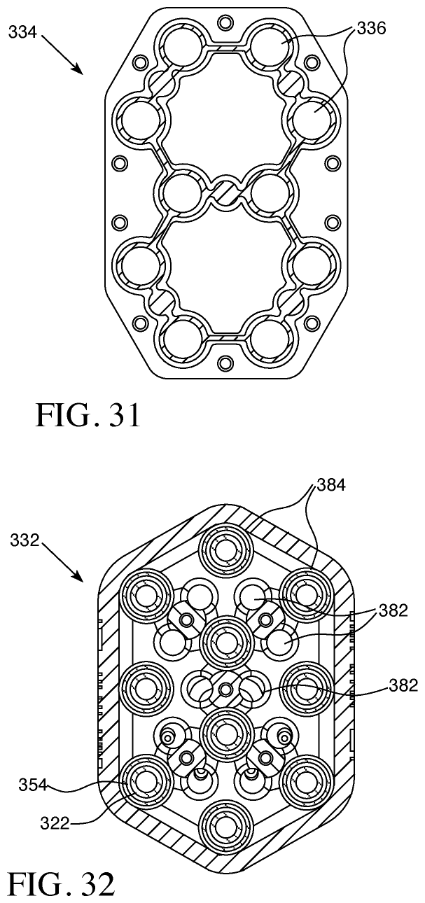

FIG. 32 depicts the distribution block 332 in more detail. The distribution block 332 includes openings 382 that are coupled to the pneumatic channels 336 and openings 384 in which the compensator sleeves 354 and extendable arms 322 are disposed. The pneumatic channel openings 382 are in communication with the compensator sleeve openings 384 to provide a vacuum pathway between the pneumatic channels 336 and the elongated openings 374 in the compensator sleeves 354. In this example, there are ten pneumatic channels 336 and ten pneumatic channel openings 382. It will be readily apparent to one of ordinary skill in the art that there may be more or fewer pneumatic channels 336 and respective pneumatic channel openings 382.

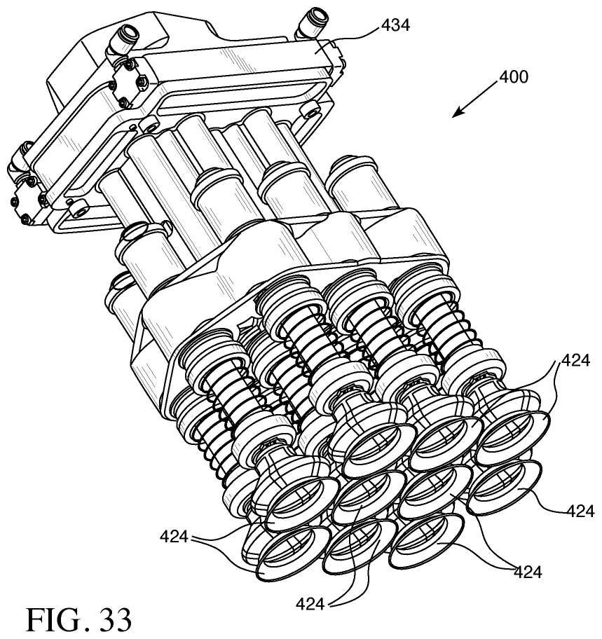

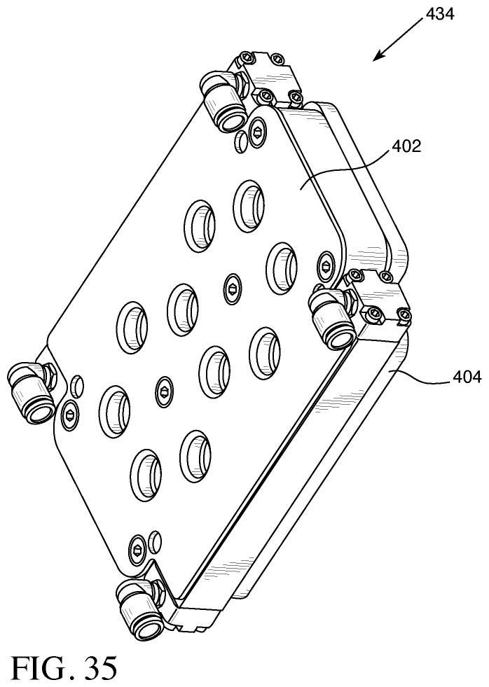

FIGS. 33-38 illustrate another embodiment of a vacuum gripping system 400 that uses a switching mechanism to activate vacuum flow to groupings of compensator assemblies based on the size of the product that the gripping device is going to grasp. One advantage of the gripping system 400 is that the zone selection features are integrated into the gripper body instead of using valving upstream on the arm. This enables the device to maximize vacuum flow to the suction cups without increasing the gripper footprint.

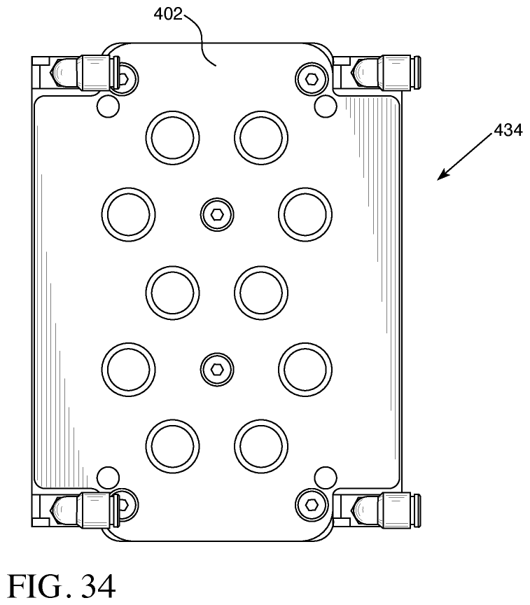

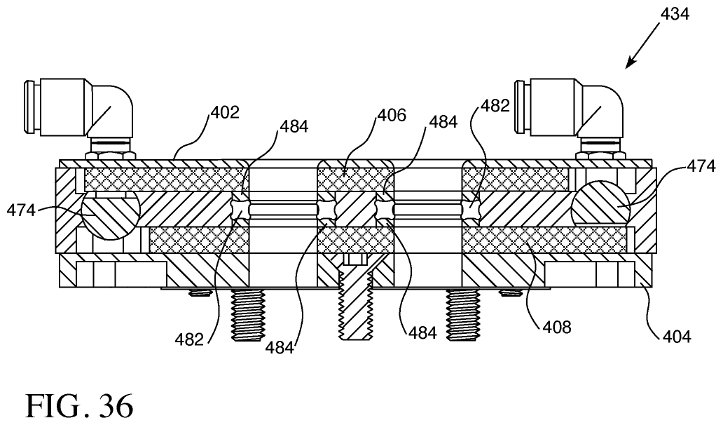

The gripping system 400 shown in FIG. 33 is similar to the gripping system 300 shown in FIG. 29, except that the upper distribution block 334 in FIG. 29 is replaced with a zone control switching block 434 in the system 400. The zone control switching block 434 is illustrated in more detail in FIGS. 34-38. The zone control switching block 434 includes a top plate 402, a bottom plate 404, and switching plates 406, 408 (shown in FIG. 36) sandwiched therebetween. The switching plates 406, 408 are each configured to switch between an “open” configuration and a “closed” configuration. When both switching plates 406, 408 are in the “open” configuration, vacuum is provided to all ten of the suction cups 424. When one of the switching plates 406, 408 is in a “closed” configuration and the other one is in the “open” configuration, vacuum is provided to a smaller grouping of the suction cups 424. For example, vacuum is provided to seven of the suction cups 424 in this configuration. When both of the switching plates 406, 408 are in the “closed” configuration, vacuum is provided to an even smaller grouping of the suction cups 424. For example, with both switching plates 406, 408 in the “closed” configuration, vacuum may be provided to only three of the suction cups 424. In this manner, zone control is accomplished without upstream valving or separate vacuum chambers, as in the embodiments shown in FIGS. 15-27. This zone control is advantageous in that the gripping system 400 can be used to effectively grip packages of varying sizes.

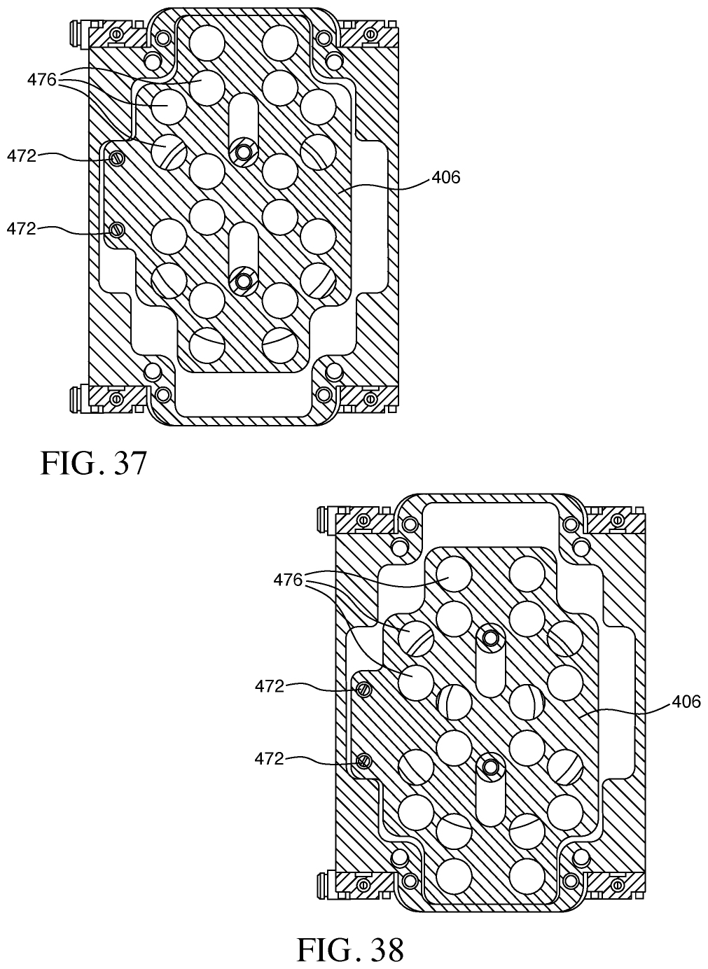

FIG. 37 illustrates one of the switching plates 406 in an “open” configuration, and FIG. 38 illustrates the switching plate 406 in a “closed” position. As shown in FIGS. 37 and 38, the plate 406 is coupled to pins 472. The pins 472 connect to a pneumatic piston 474 (shown in FIG. 36) configured to move the switching plate 406 back and forth between the “open” configuration and the “closed” configuration.

The switching plates 406, 408 each include an array of openings 476. In the embodiment illustrated in FIGS. 33-38, the zone control switching block 434 is coupled to an array of ten suction cups 424. As such, when both of the switching plates 406, 408 are in the “open” configuration, all ten of the openings 476 in the top switching plate 406 are in alignment with all ten of the openings 476 in the bottom switching plate 408 and vacuum is provided to all ten suction cups 424. In this configuration, the gripping system 400 has the largest gripping area for picking larger parcels. When one of the switching plates 406, 408 is in the “open” configuration and the other one is in the “closed” configuration, only seven of the openings 476 in the top switching plate 406 are aligned with openings 476 in the bottom switching plate 408 and vacuum is provided to seven of the suction cups 424. In this configuration, the gripping area is reduced for picking smaller parcels. When both of the switching plates 406, 408 are in the “closed” configuration, only three of the openings 476 in the top switching plate 406 are aligned with openings 476 in the bottom switching plate 408 and vacuum is provided to only three of the suction cups 424. In this configuration, the gripping area is further reduced for picking even smaller parcels. The invention is not limited to a suction cup array having ten suction cups. It will be well understood by one of ordinary skill in the art that the suction cup array may have any desired number of suction cups and the zone control switching block 434 may be configured to reduce the gripping area by any desired amount to result in a gripping area of a desired size, depending on the size of the packages to be picked by the vacuum gripping system.

The switching plates 406, 408 are configured to slide relative to each other while preventing vacuum leakage and minimizing friction. As such, as shown in FIG. 36, rubber o-rings 482 and teflon washers 484 are disposed between the plates 406, 408. The rubber o-rings 482 provide compression between the plates 406, 408. The teflon washers 484 provide a low friction sliding surface between the plates 406, 408. In this manner, a good seal is maintained and friction between the switching plates 406, 408 is minimized.

The zone control switching block 434 may be added to the gripping systems in any of the above embodiments in order to provide zone control to accommodate various package sizes. Further, the switching mechanism is not limited to the switching block 434, and it will be well understood by one of ordinary skill in the art that a similar switching mechanism may be incorporated into another area of the gripping system.

Although several aspects of the invention have been disclosed in the foregoing specification, it is understood by those skilled in the art that many modifications and other aspects of the invention will come to mind to which the invention pertains, having the benefit of the teaching presented in the foregoing description and associated drawings. For example, the vacuum gripping systems described herein may be modified so that the biasing member is a compression spring that is positioned inside the compensator sleeve or inside the extendable member, rather than positioned on the outside of the extendable member.

It is thus understood that the invention is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described invention.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A gripping system for grabbing and releasing an object using a robotic arm, the gripping system comprising:
a base frame for operably engaging the robotic arm, wherein the base frame comprises a pneumatic source connector;
an extendable member configured to extend and retract relative to the base frame, the extendable member having a distal end and a proximal end, the extendable member further having an extended position and a retracted position defining a range of motion therebetween;
a vacuum cup coupled to the distal end of the extendable member, the vacuum cup configured for operably engaging a surface of an object and forming a pneumatic seal on the surface; and
a pneumatic pathway extending from the vacuum cup to the pneumatic source connector, wherein the pneumatic pathway passes through the extendable member such that the vacuum cup remains in pneumatic communication with the pneumatic source connector throughout the range of motion of the extendable member.

2. The gripping system of claim 1, further comprising a plurality of vacuum cups, each vacuum cup in pneumatic communication with the pneumatic source connector through the pneumatic pathway that passes through the extendable member.

3. The gripping system of claim 2, further comprising a cup frame plenum disposed between the distal end of the extendable member and the plurality of vacuum cups, wherein the cup frame plenum comprises a respective plurality of cup channels in fluid communication with the plurality of vacuum cups.

4. The gripping system of claim 1, further comprising a compensator sleeve coupled to the base frame and surrounding the extendable member, wherein the extendable member is configured to translate linearly relative to the compensator sleeve.

5. The gripping system of claim 4, wherein an inner diameter of the compensator sleeve is no more than 0.1 mm larger than an outer diameter of the extendable member.

6. The gripping system of claim 4, wherein the compensator sleeve comprises a compensator sleeve opening in a sidewall of the compensator sleeve,
wherein the extendable member comprises an extendable member opening in a sidewall of the extendable member, the extendable member opening being in fluid communication with the compensator sleeve opening,
wherein the extendable member comprises an elongate pneumatic chamber that extends from the elongate member opening to the vacuum cup, and
wherein the pneumatic pathway comprises the compensator sleeve opening in fluid communication with the pneumatic source connector, the extendable member opening in fluid communication with the compensator sleeve opening, the elongate pneumatic chamber in fluid communication with the extendable member opening, and the vacuum cup in fluid communication with the elongate pneumatic chamber.

7. The gripping system of claim 6, wherein the compensator sleeve opening is an elongate opening that maintains communication with the extendable member opening throughout the range of motion of the extendable member.

8. The gripping system of claim 6, wherein the extendable member opening is an elongate opening that maintains the fluid communication with the compensator sleeve opening throughout the range of motion of the extendable member.

9. The gripping system of claim 4, further comprising a biasing member for biasing the extendable member in the extended position, wherein the biasing member is operably secured to the compensator sleeve and the extendable member.

10. The gripping system of claim 9, wherein the biasing member is a coil spring.

11. The gripping system of claim 4, wherein the base frame comprises a plurality of pneumatic source connectors,
wherein the compensator sleeve comprises a respective plurality of compensator sleeve openings in a sidewall of the compensator sleeve,
wherein the extendable member comprises a respective plurality of extendable member openings in a sidewall of the extendable member, each one of the extendable member openings being in fluid communication with one of the compensator sleeve openings, and
wherein the extendable member comprises a respective plurality of elongate pneumatic chambers, each one of the elongate pneumatic chambers being in fluid communication with one of the extendable member openings.

12. The gripping system of claim 11, further comprising a respective plurality of groups of vacuum cups, wherein each one of the groups of vacuum cups is in pneumatic communication with one of the pneumatic source connectors through one of the elongate pneumatic chambers, one of the extendable member openings, and one of the compensator sleeve openings.

13. The gripping system of claim 1, further comprising a plurality of vacuum cups and a respective plurality of extendable members, wherein each one of the vacuum cups is coupled to a distal end of a respective one of the extendable members.

14. The gripping system of claim 13, wherein the base frame comprises a plurality of pneumatic source connectors, and wherein the system further comprises a vacuum distribution block having a respective plurality of vacuum zones, wherein each one of the vacuum zones is in fluid communication with one of the pneumatic source connectors.

15. The gripping system of claim 13, wherein the plurality of vacuum cups are divided into two or more zones, and wherein the system further comprises a switching mechanism configured to activate or deactivate each one of the zones.

16. A gripping system for grabbing and releasing an object using a robotic arm, the gripping system comprising:
a base frame for operably engaging the robotic arm, wherein the base frame comprises a pneumatic source connector;
an extendable member configured to extend and retract relative to the base frame, the extendable member having a distal end and a proximal end, the extendable member further having an extended position and a retracted position defining a range of motion therebetween;
a vacuum cup coupled to the distal end of the extendable member, the vacuum cup configured for operably engaging a surface of an object and forming a pneumatic seal on the surface;
a compensator sleeve surrounding the extendable member, wherein a position of the compensator sleeve is fixed relative to the base frame, and wherein the extendable member is configured to linearly translate relative to the compensator sleeve; and
a pneumatic pathway extending from the vacuum cup to the pneumatic source connector, wherein the pneumatic pathway passes through the extendable member such that the vacuum cup remains in pneumatic communication with the pneumatic source connector throughout the range of motion of the extendable member.

17. The gripping system of claim 16, further comprising:
a plurality of extendable members;
a respective plurality of vacuum cups; and
a respective plurality of compensator sleeves.

18. The gripping system of claim 17, further comprising a vacuum distribution block for fluidly coupling the plurality of vacuum cups to the pneumatic source connector, wherein the plurality of compensator sleeves are fixedly attached to the vacuum distribution block.

19. The gripping system of claim 16, further comprising a plurality of pneumatic source connectors in fluid communication with a respective plurality of groups of vacuum cups.

20. The gripping system of claim 16, further comprising a plurality of groups of vacuum cups in fluid communication with a switching mechanism, wherein the switching mechanism is configured to block the pneumatic pathway to one or more selected groups of vacuum cups.
